(19) United States
(12) Patent Application Publication
(10) Pub. No.: US 2013/0211841 A1
(43) Pub. Date: Aug. 15, 2013

(54) Multi-Dimensional Interactions and Recall

(71) Applicant: Fluential, LLC, (US)

(72) Inventors: Farzad Ehsani, Sunnyvale, CA (US); Demitrios L. Master, Cupertino, CA (US); Silke Maren Witt-Ehsani, Sunnyvale, CA (US)

(73) Assignee: FLUENTIAL, LLC, Sunnyvale, CA (US)

(21) Appl. No.: 13/767,034

(22) Filed: Feb. 14, 2013

Related U.S. Application Data
(60) Provisional application No. 61/599,054, filed on Feb. 15, 2012.

(51) Int. Cl. G10L 21/00

(52) U.S. Cl. CPC G10L 21/00
USPC 704/270.1

(57) ABSTRACT

Methods for initiating actions based on analysis of multi-dimensional interactions are presented. Electronic devices can acquire sensor data representing interactions among multiple entities. Analysis engines can use the interaction data to create or otherwise manage interaction guide queues based on conceptual threads associated with the interactions. Interaction guides within the queue comprise instructions, possibly domain-specific instructions, for devices to participate in the interactions. Contemplated engines manage the queues as a function of attributes, for example priority, derived from the interactions.

This application claims the benefit of priority to U.S. provisional application having Ser. No. 61/599,054, filed on Feb. 15, 2012.

### FIELD OF THE INVENTION

The field of the invention is human-computer interaction technologies.

### BACKGROUND

A multimodal conversational interaction is an interplay between at least two entities using language or other modalities. One of the simplest forms of an interaction is a dialog that has only one topic/goal/purpose, and only two participants where control of a conversation by one participant shifts to another participant as the participants respond to each other. Most dialogs involving electronic devices are much more complicated requiring extensive computational capability to manage the ebb and flow of contexts through the dialog. One dimension along which dialogs could be handled includes the manner in which multiple topics/goals/purposes are processed. Two types of dialogs that have been discussed in the literature are embedded dialogs and multithreaded dialogs. These are defined and illustrated in FIG. 1.

In embedded dialogs, a participant starts with a dialog topic/goal/purpose “A” around which a conversation pivots. During the conversation, the participants switch to dialog topic/goal/purpose “B”. When the participants complete dialog topic/goal/purpose “B” they return to dialog topic/goal/purpose “A” in a seamless fashion as shown on the right side of FIG. 1. For example, two people could be talking about buying a car, then switch to talking about where to go for dinner, then once they had decided about dinner return to talking about buying a car.

The term “Multi-threaded dialogs” is used to mean a dialog interaction that comprises more than one topic, goal, or purpose. For example, as illustrated on the left side of FIG. 1, suppose that two people are having a conversation or dialog about buying a car next week then suspend that discussion to talk about where to go for dinner that night. They might also return to discussing the car purchase at some point. That dialog could be said to have at least two threads, one for the car buying discussion and one for the dinner discussion where the topics, goal, or purposes are intermingled. In particular this terminology is used to describe dialogs that shift back and forth between threads, e.g. talking about car buying, then dinner then car buying then more about dinner, as opposed to embedded conversations, e.g. talk about buying the car, switch to talking about dinner, complete that discussion and then return to talking about buying the car. Tracking, identifying, or recalling the topics, goal, or purposes of intermingled dialogs, including interactions comprising multiple modalities (e.g., speech, movement, location, vision, etc.), is quite difficult for computational systems.

Others have attempted to address specific types of dialog management in the past. For example Grosz and Sidner 1986 (Grosz, B. and Sidner, C. “Attentions, intentions, and the structure of discourse”. Computational Linguistics Vol. 12 No, 3, July-September 1986, pages 175-204), use a stack mechanism to represent a dialog structure. Such an approach is acceptable for representing embedded dialogs but much less suitable for representing interleaved dialogs of the type found in multithreaded dialogs, let alone multi-modal dialogs where the dialog input can span across many modalities (e.g., audio, video, image, tactile, gestures, etc.). The Grosz and Sidner approach pushes dialog segments onto a stack. A dialog segment is a natural piece of actual language being produced by the participants in which all the terms relate to a single dialog topic/goal/purpose. Each new dialog topic/goal/purpose is associated with a new dialog segment. Because of the stack structure only dialog segments on the top of the stack are accessible at any time. This means that if one finishes the current dialog topic/goal/purpose, the most recently active prior topic/goal/purpose will then be available but older, more remote topic/goal/purposes will not. Older material can become accessible, as current dialog segments are completed or abandoned. New input is processed as:
1. Part of the current dialog segment and topic/goal/purpose
2. Introducing a new dialog segment and topic/goal/purpose
3. Relating to a topic/goal/purpose further down the stack which requires the material above it to be removed from the stack and that material will no longer be available

FIG. 2 illustrates such stack-based dialog systems and the three input methods above.

Dialog processing architectures that have attempted to handle multi-threaded dialog include those disclosed by Lemon (Lemon et al. “Multithreaded Context for Robust Conversational Interfaces Context-Sensitive Speech Recognition and Interpretation of Corrective Fragments”, ACM Transactions on Computer-Human Interaction, Vol. 11, No. 3, September 2004, Pages 241-267; Oliver Lemon, Alexander Gruenstein, Alexis Battle, and Stanley Peters, “Multi-tasking and Collaborative Activities in Dialogue Systems”, in proceedings of 3rd SIGdial Workshop on Discourse and Dialogue, July 2002, Pages 113-124). In the Lemon approach each dialog topic/goal/purpose is established as a separate thread where each separate thread is maintained in parallel as illustrated in FIG. 4. In this architecture it is possible to switch between threads at will without constraints on recency, or relations between topics. As depicted in FIG. 4, the architecture new input can continue an existing dialog thread or initiate a new dialog thread. The Lemon model fails to account for placing constraints on shifts from one thread to another as occurs in natural human dialogs, especially within multi-modal interactions that entail modalities beyond speech.

Additional efforts directed toward computer-based processing of dialogs include the following:
Cavedon et al. “Developing a Conversational In-Car Dialog System”, 12^{th} International Congress on Intelligent Transportation Systems, 2005.
Lemon, et al. “The WITAS Multi-Modal Dialog System I” in Technology (Citeseer, 2001) pages 4-7;
European patent application publication EP 1 363 200 to Roushar titled “Multi-Dimensional Method and Apparatus for Automated Language Interpretation”, filed May 13, 2003;
U.S. Pat. No. 7,242,752 to Chiu titled “Behavioral Adaptation Engine for Discerning Behavioral Characteristics of Callers Interacting with an VXML-Compliant Voice Application”, filed Jul. 2, 2003;
U.S. Pat. No. 7,257,537 to Ross et al. titled “Method and Apparatus for Performing Dialog Management in a Computer Conversational Interface”, filed Jan. 10, 2002;
U.S. Pat. No. 7,487,095 to Hill et al. titled “Method and Apparatus for Managing User Conversations”, filed Sep. 2, 2005;
U.S. Pat. No. 7,609,829 to Wang et al. titled “Multi-Platform Capable Inference Engine and Universal Grammar Language Adapter for Intelligent Voice Application Execution”, filed Mar. 17, 2004;
U.S. patent application publication 2005/0055321 to Fratkina et al. titled “System and Method for Providing an Intelligent Multi-Step Dialog with a User”, filed Jul. 13, 2004; and
U.S. patent application publication 2008/0134058 to Shen et al. titled “Method and System for Extending Dialog Systems to Process Complex Activities for Applications”, filed Nov. 30, 2006.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Although some effort has been applied toward dialog management, there still remains a need for initiating actions based on multi-dimensional interactions, especially interactions comprising multiple modalities. The inventive matter brings significant innovation to this field.

### SUMMARY OF THE INVENTION

The inventive subject matter provides apparatus, systems and methods in which one can use data representative of a user's interactions with an environment to establish one or more conceptual or contextual threads associated with the interactions. A queue of interaction guides (e.g., actions to be taken, tasks, interaction responses, etc.) can be constructed and managed based on the conceptual threads where the interaction guides instruct electronic devices on how to participate within the interaction. Conceptual threads in speech-only interaction can be considered to be identical to dialogue threads. One aspect of the inventive subject matter includes a method of initiating actions based on multi-dimensional interactions. The method can include configuring an electronic device (e.g., cell phone, tablet, computer, security camera, etc.) to acquire a digital representation of an interaction. Interactions can include an interplay between two entities involving one or more modalities (e.g., sounds, images, gestures, motions, signal exchanges, emotions, etc.). The method can include providing access to an interaction analysis engine configured to analyze the interaction data. The analysis engine can differentiate two or more conceptual threads relating to the interactions where the conceptual threads represent meaning associated with the interaction. Meaning can include goals, topics, functions, purposes, or other quantifiable representations of the meaning. The conceptual threads can be mapped to one or more Meaning Invariant Units (MIUs) of interactions that are modality-invariant (i.e., invariant with respect to voice, touch, gesture, images, time, or even sensors such as GPS, temperature, etc.), language independent, or both for example. The MIUs can be considered a digital quantification or representation of a meaning associated with a part of the interaction.

The analysis engine can further modify a queue of interaction guides as a function of attributes derived from the MIU where interaction guides can include instructions to a computing device on how to continue participating in an interaction with a user. Interaction guides are typically associated with a domain. Each domain typically has a number of different interaction guides. For example, in the travel domain there might be one interaction guide for making a flight reservation, another interaction guide to check the weather forecast and yet another interaction guide to make a hotel reservation.

Example attributes can include urgency, priority, importance, initiator, or other factors that can affect queue ordering. For example, if a conceptual thread is associated with an emergency situation, the derived attribute could include both priority and importance causing corresponding interaction guides to be shifted to the top of a queue for processing quickly. Contemplated methods further include configuring the electronic device to initiate an action (e.g., a transaction, start a software process, generate a response, make a phone call, request information from a user, send a message, etc.).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a known prior art multi-threaded dialog and an embedded dialog.

FIG. 2 illustrates a prior art stack-based dialog processing system.

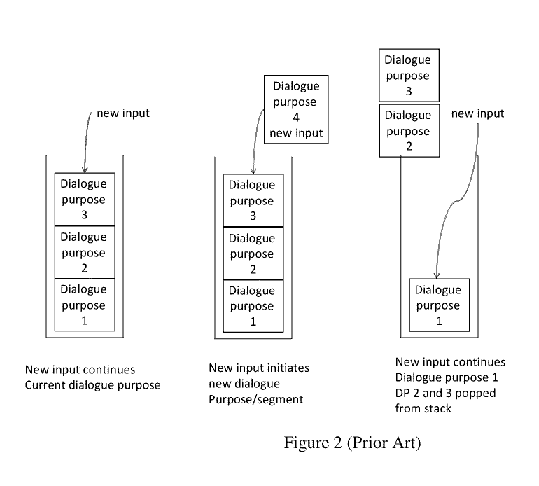

FIG. 3 illustrates the overall architecture or ecosystem of the system.

FIG. 4 illustrates a thread-based dialog processing system as contemplated by Lemon.

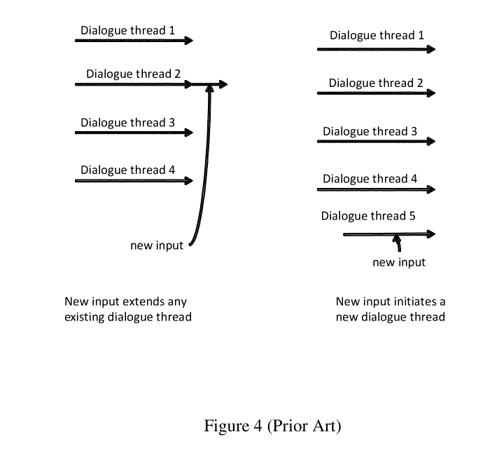

FIG. 5 illustrates an interaction guide in relation to data input and the analysis engine.

FIG. 6 illustrates a priority queue for interaction guides where the incoming input from the user maps to an interaction guide that is higher priority than those already on the stack.

FIG. 7 illustrates inserting an interaction guide within a queue based on priority.

FIG. 8 illustrates merging information into a current interaction guide in a queue.

FIG. 9 illustrates re-prioritizing or reordering a queue of interaction guides.

FIG. 10 illustrates a reactivation of an interaction guide from the dormant queue.

FIG. 11 illustrates the relationship between MIUs and conceptual threads.

FIG. 12 illustrates a method of initiating actions based on multi-dimensional interactions.

### DETAILED DESCRIPTION

It should be noted that while the following description is drawn to a computer/server based interaction processing system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including generating network signals capable of configuring computing devices to initiate an action in response to receiving the signals to allow the computing devices to partake in an interaction, a dialog for example, with a user of the device.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. With the context of networking “coupled to” and “coupled with” can be construed to mean “communicatively coupled with” where two entities can exchange data over a network possibly through one or more intermediary networking nodes.

The disclosed inventive subject matter provides computational support for controlling constraints on shifting from one interaction thread to another, especially in multi-modal interactions. The Applicant's technology is called Speech-enabled Operating system For Intelligent Assistants, “SOFIA” for short.

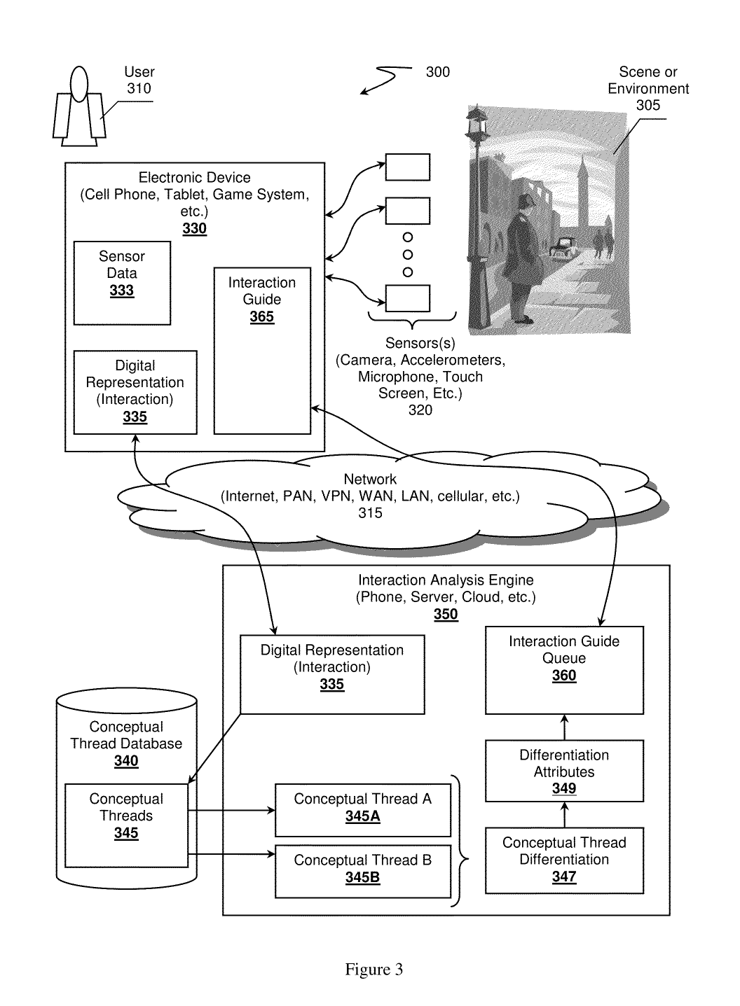

FIG. 3 illustrates interaction analysis ecosystem 300 were user 310 is able to capture sensor data 333 from one or more sensors 320 via electronic device 330. More specifically, user 310 can utilize electronic device 330 to capture sensor data 333 representative of one or more interactions with environment 305. Electronic device 330 can convert sensor data 333 into one or more digital representations 335 of the interactions. For example, user 310 can capture an image data or audio track via their cell phone where the image data and audio track reflects a static or dynamic set of occurrences within environment 305. Example computing devices that can be configured to operate as electronic device 330 include smart phones, tablet computers, phablets, game consoles or devices, cameras, appliances, kiosks, or other types of computing devices.

Sensors 320 can include a wide variety of sensors. In some embodiments, electronic device 330 can comprises one or more internal sensors, possibly including a camera, accelerometer, microphone, touch screen, or other sensors. Further, sensors 320 can also include sensors external to electronic device 330. For example, external sensors could include security cameras, search engines, weather stations, or other types of sensors. Regardless of the nature of sensors 320, sensor data 333 can be obtained by electronic device 330 via a direct connection or an indirect connection, possibly via network 315.

Just as sensors 320 can include a wide variety of sensor types, sensor data 333 represent a broad spectrum of data modalities depending on the nature of the corresponding sensors 320. Example data modalities can include data the represents one or more of human speech, text data, visual data, kinesthetic data, auditory data, taste data, ambient data, or other types of data. Thus, the resulting digital representation 335 of the interactions can include multiple modalities. For example, digital representation 335 could include human speech along with another modality (e.g., text data, visual data, kinesthetic data, auditory data, taste data, ambient data, or other types of data).

Digital representation 335 can be considered a compilation of sensor 333 into a form readily analyzable by interaction analysis engine 350. For example, digital representation 335 could comprises an MPEG4 video file that includes motion image data as well as audio data. When desirable, interaction analysis engine 350 can obtain the digital representation 335 of the interaction. As illustrated, in some embodiments, interaction analysis engine 350 can obtain digital representation 335 over network 115. For example, interaction analysis engine 350 could operate as a virtual server within a cloud infrastructure (e.g., Amazon EC2, Microsoft Azure, etc.) as a for-fee service. One should appreciate that interaction analysis engine 350 could be disposed within electronic device 310, or have its roles or responsibilities distributed across other elements in the ecosystem.

Interaction analysis engine 350 can be configured to analyze digital representation 335 based on techniques associated with the data modalities within digital representation 335. For example, if digital representation 335 comprises image data, the image data can be analyzed via Scale Invariant Feature Transform (SIFT), Binary Robust Invariant Scalable Keypoints (BRISK), Optical Character Recognition (OCR), or other techniques to generate image attributes or descriptors. Further, image digital representation 335 comprises audio data, interaction analysis engine 350 can apply one or more known Automated Speech Recognition (ASR) to extract words. Through comparing the attributes derived from digital representation 335 (e.g., words, images, gestures, etc.), interaction analysis engine 350 can differentiate among two or more conceptual communication threads 345 as presented by conceptual thread 345A and conceptual thread 345B. In some embodiments, interaction analysis engine 350 can determine the conceptual threads by using attributes from digital representation 335 to query conceptual thread database 340 for conceptual threads 345 for thread templates that satisfy the query. The templates can be populated based on information retrieved from digital representation 335 or even from sensor data 333.

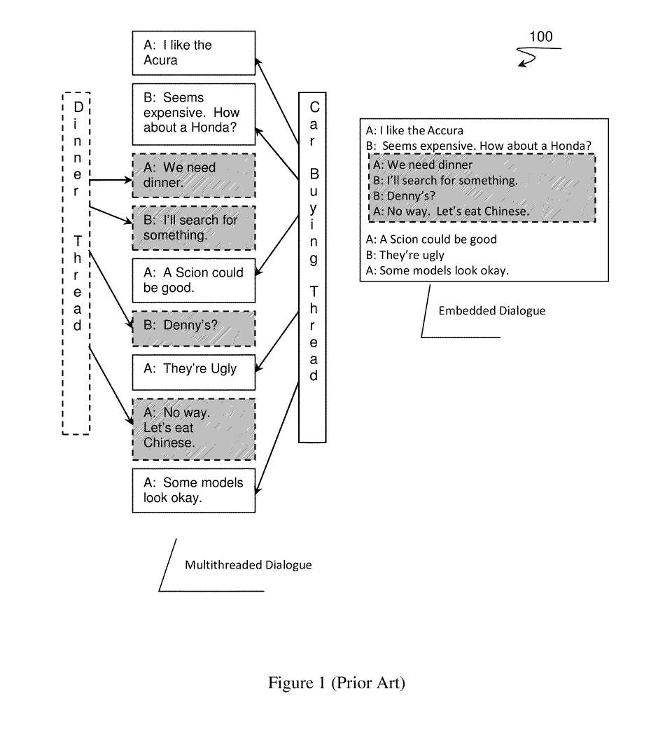

Conceptual threads 345A and 345B can be considered representative of dialogs interpreted from digital representation 335. For example, conceptual threads 345A could correspond to the dinner thread in FIG. 1 while conceptual thread 345B could correspond to the car buying thread in FIG. 1. One should appreciate that conceptual threads 345A and 345B can include information obtained from different modalities (e.g., sign language, speech, gestures, images, etc.). Further conceptual threads 345A and 345B can also be considered instantiated objects that can be managed as distinct objects, especially in view that conceptual threads can exist over extensive periods of time (e.g., day, week, month, year, etc.).

Interaction analysis engine 350 compares two or more of conceptual threads 345A and 345B to determine differences among the threads as represented by conceptual thread differentiation 347. Interaction analysis engine 350 derives one or more differentiation attributes 349 from differentiation 347. Example differentiation attributes that relate to conceptual threads 345A and 345B include differences in time relating to topic, location or distance differences (e.g., proposed dinning location versus location to buy a car), inferred preferences, or other differences such as topic or conceptual marker related to one but not the other thread ('weather forecast' versus ‘car buying’ for example).

Interaction analysis engine 350 can leverage differentiation attributes to modify a queue of interactions guides 360 where the queue manages when one or more of interaction guides 365 should be triggered by conceptual threads 345A or 345B. Modifying queue 360 can include actions such as queue creation, queue deletion, add an interaction guide, remove an interaction guide, prioritize an interaction guide, modify an interaction guide, insert an interaction guide, merge an interaction guide, change a state of an interaction guide, re-order an interaction guide, or other types of actions. modified by can be Interaction guides 365 can be considered one or more device command sets that configure electronic device 330 to take action with respect to the interaction in environment 305.

Consider a scenario where user 210 is shopping in a store while also conversing with a friend on a cell phone. The conversation can shift between discussing the shopping interaction in the store (e.g., sending images of cloths, discussing fashion, etc.) as a first conceptual thread and discussing seeing a movie as a second conceptual thread. Interaction analysis engine 350 can detect the two threads and could determine differences between the threads. Example differences could include differences in related locations, differences in purchasing protocols, difference in times between events, or other differences. Based on the differences, interaction analysis engine 350 can re-prioritize one or more of interaction guide 365 in queue 360 to fit the current concepts under discussion. For example, if getting to the movie is urgent, then engine 350 configure the cell phone, in order, with an alert about the movie, followed by preparing an on-line transaction for a movie ticket, and preparing for a financial transaction with the store. Alternatively, if the movie event is not urgent, the ordering of the interaction guides could be preparing for a financial transaction with the store, preparing an on-line transaction for a movie ticket, and generating an alert about the movie.

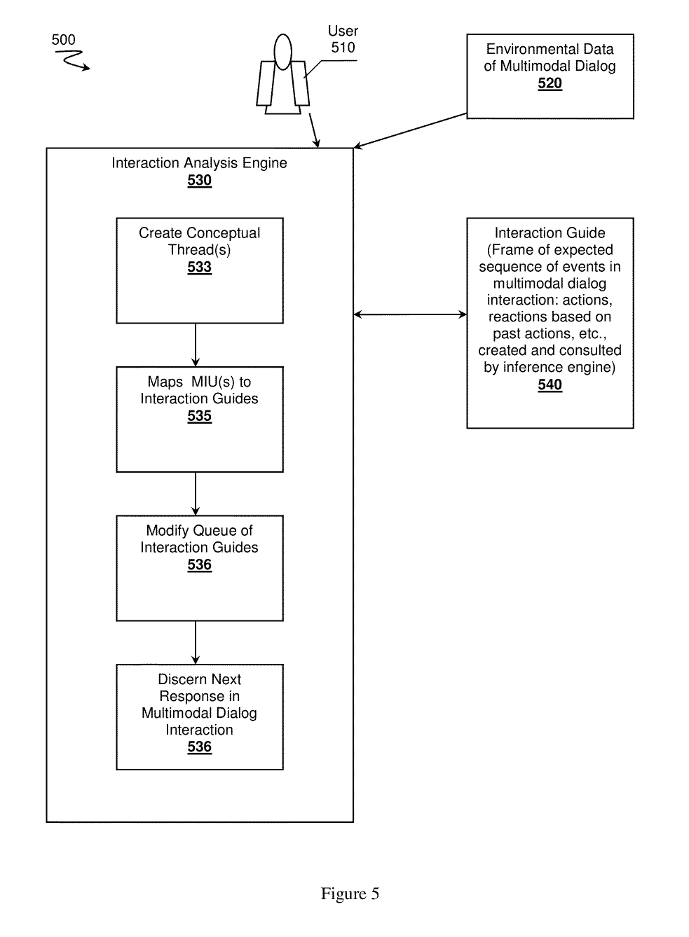

FIG. 5 depicts an interaction guide 540 and describes its basic function. Interaction guides are frame data structures that capture the events and the expected sequence of events in a multimodal conversational dialog interaction. Note that interaction guide 540 can be defined a priori or learned and/or possibly modified by the system. Interaction guides 540 are compilations of events in temporal order such as actions or reactions. Interaction guides 540 are consulted by the interaction analysis engine 530 in order to determine what response to make next in a multimodal dialog interaction. FIG. 5 depicts the relationship between an interaction guide 540, the interaction analysis engine 530 and input data from users 510 and environmental data 520. Multimodal response input along with environmental data 520 associated with the multimodal dialog is conveyed to the interaction analysis engine 530. The interaction analysis engine 530 creates conceptual threads 533. The interaction analysis engine 530, by using search, analysis and mapping of attributes to interaction guides 540, calculates a priority value for each active interaction guide and modifies the queue of interaction guides 536 such as to identify or discern the next response to be made in the multimodal dialog 538.

The approach taken by SOFIA maintains a queue of interaction guides. The following discussion presents the inventive subject matter from the perspective of a priority queue. The reader should appreciate that the inventive subject matter extends beyond a priority queue of interaction guides per se and can be readily extended to other types of multi-dimensional interaction management.

Interaction guides are frameworks for conversational or interaction behaviors that give structure or options for carrying out an interaction, a conversation for example, for a particular topic, subject domain, function, or other interplay. The techniques disclosed by Grosz and Sidner, or Lemon for processing dialog segments can be suitably adapted to function along with interaction guides in the disclosed ecosystem. However, such approaches require modifications to process interaction guides to support the herein disclosed inventive features: active interactions, inactive interactions, passive interactions, topics, goals, purposes, etc.

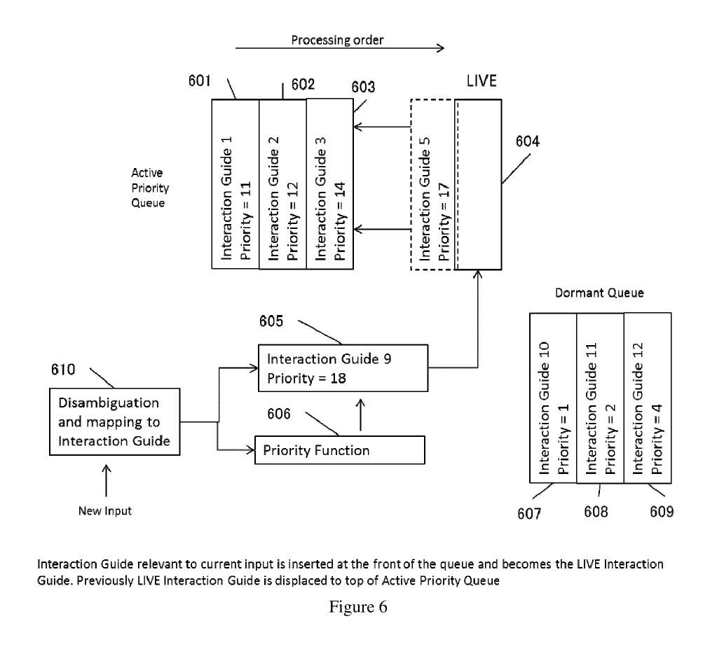

Interaction guides differ from discourse segments or dialog threads in that the interaction guides have information encoded about the possible form of interaction resulting from the use of the interaction guide. Interaction guides include both interaction information and expert domain knowledge. More items are accessible than in the Grosz and Sidner approach because the contemplated inventive approach comprises a priority queue, or other type of management queue, containing the interaction guides. Contemplated queues can be dynamically reordered during the course of one or more interactions, based on a priority function. In the Grosz and Sidner model, once a discourse segment is on the stack, the segment's position relative to the other discourse segments cannot be altered. In the SOFIA system new interaction guides are placed in position in the queue based on their priority, or other processing attribute, whereas in the Grosz and Sidner system new discourse segments are always pushed onto the top of the stack. The SOFIA approach differs from the multithreaded approach in Lemon in having the queue structure in which priority ordering, or other attribute ordering, determines what interaction topics/goals/purposes will be active currently or which ones will become active once the current one is finished. Multithreaded processing places no inherent restriction on ordering or on which of the previous interaction topics/goals/purposes can become active at any time. Both the multithreaded interaction processing and the SOFIA interaction processing will handle interleaved interaction topics/goals/purposes. The SOFIA approach ties accessibility of non-current interaction topics/goals/purposes to priorities assigned in mapping input to interaction guides. The system determines that a change in topic is required when the priority of the interaction guide resulting from processing new input is higher than the priority of the current interaction guide. One should further appreciate that a user utterance can be the input that initiates a change in topic as well as inputs from the device or the system. When a change of topic is initiated it can cause re-prioritization of the interaction queue. The SOFIA priority queue processing for multithreaded interaction is illustrated in FIGS. 6-10. Note that processing order flows from left to right in FIGS. 6-10.

When the new input is resolved as a particular interaction guide 605, that cannot be merged with another interaction guide in the queue, and the priority assigned is higher than the current interaction guide. The new interaction guide is placed at the front of the queue. FIG. 6 depicts the means by which the priority of interaction guides can shift in a queue. Each interaction guide (i.e. 601, 602, etc) is assigned a numerical priority by a priority function 606 that establishes its processing order. As input data is analyzed and disambiguated by the disambiguation function 610 in an ongoing multimodal dialog interaction, the priority function 606 may assign a higher priority to a particular interaction guide that would cause it to displace the existing highest priority interaction guide 603, making it the “live” interactive guide 604.

Note that the interaction analysis engine can be domain specific. Inference engines could be dedicated to a specific game, an educational topic or a field of work for example. In such cases, the dedicated interaction analysis engine would likely possess a different or specialized prioritization algorithm.

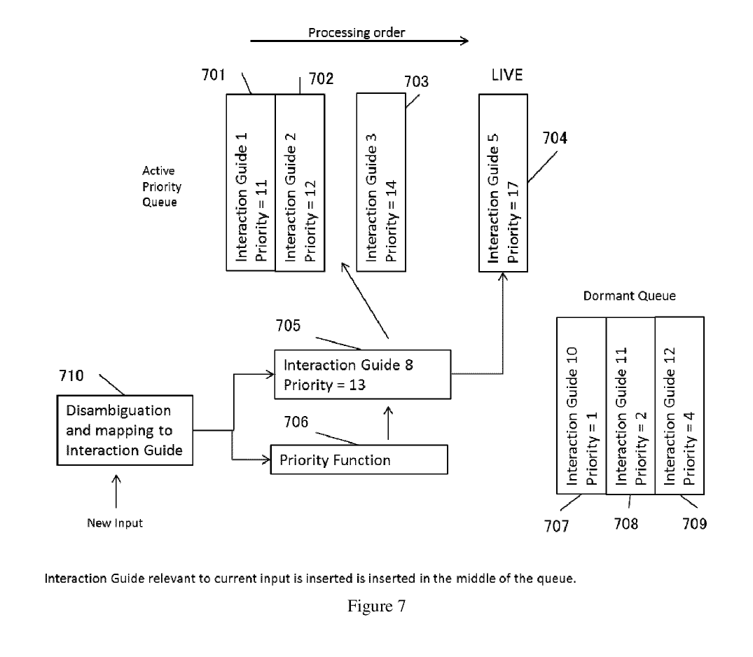

When the priority assigned to the new interaction guide 705 resulting from processing the latest input is lower than the priority of the current active interaction guide at the front of the queue, then the new interaction guide is inserted into the middle of the queue 702 703 at the appropriate point based on its priority score as illustrated by FIG. 7.

If the new input continues the current live interaction guide 805, it will be resolved as needing the same interaction guide as the current live one 804, and information will be merged.

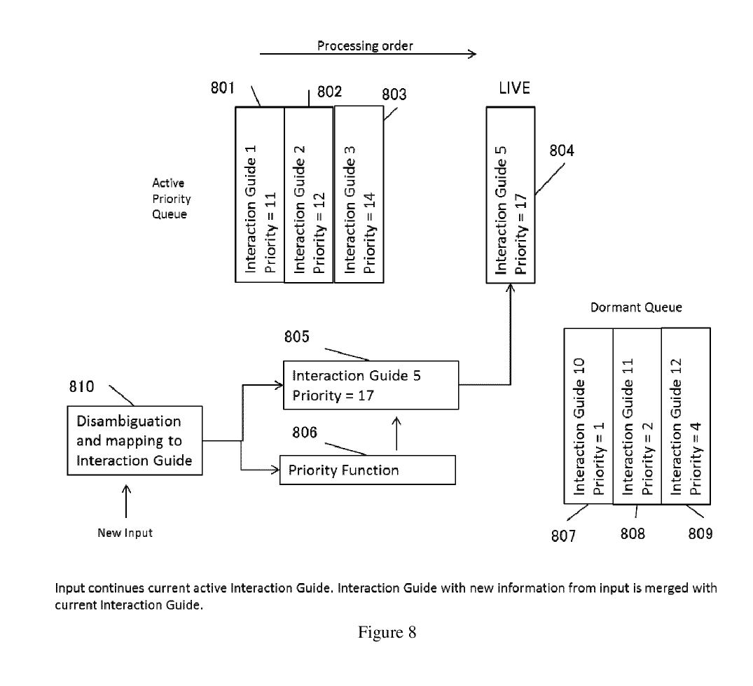

FIG. 8 illustrates the influence of new input inserting an interaction guide into an ordered queue of interaction guides 801 802 803.

In this case the input continues a prior interaction guide that is in the active queue but is not the live interaction guide. The interaction guide identified for the new input is merged with the prior instance of the interaction guide. If the new priority score is higher than that for the live interaction guide, the merged interaction guide 804 moves to the front of the queue. This entire process is illustrated in FIG. 8.

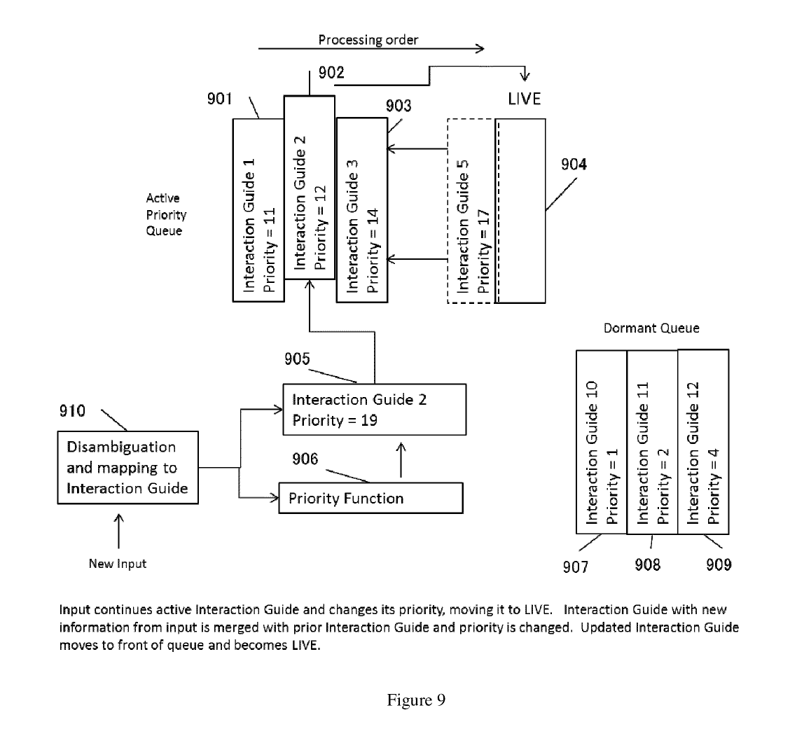

FIG. 9 illustrates another case. If the priority score for the merged interaction guide 905 is a threshold amount less or in some cases even some threshold more than the priority for the live interaction guide 904, it will be positioned in the active queue 901 902 903 according to its priority value.

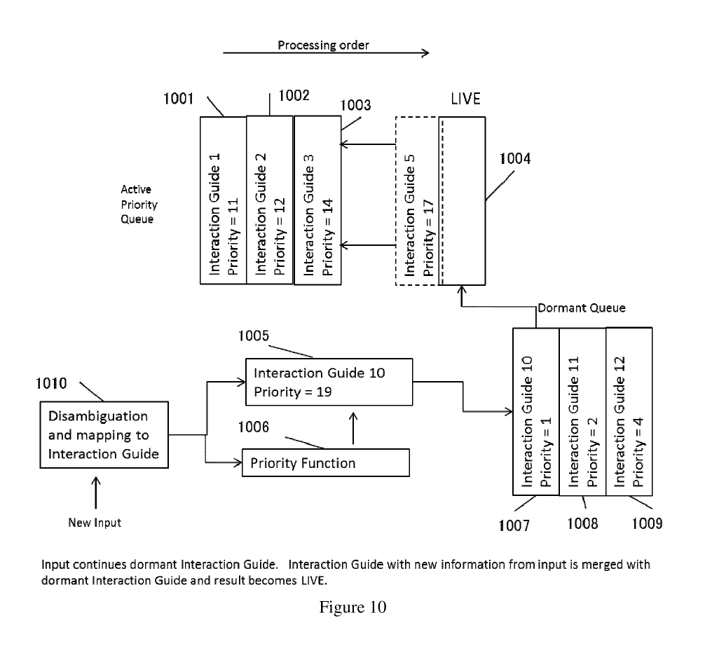

FIG. 10 illustrates the case where input continues the currently active interaction guide 1005 utilizing an interaction guide 1007 assigned to the dormant queue. In this case, the input continues a prior interaction guide 1007 that is in the dormant queue. The interaction guide identified for the new input 1005 is merged with the prior instance of the interaction 1007 guide in the dormant queue. If the new priority score is within some other threshold above the live interaction guide, the merged interaction guide is moved to the live position at the front of the queue displacing the current live interaction guide 1004. If the priority score of the merged interaction guide is some threshold less than the score for the live interaction guide or based on some other heuristics then it will be placed in the active or dormant queue as appropriate based on its score.

Priority, or other queue-controlling attribute, can be established via a priority module. The priority module makes use of information sources available in the system, or accessible by the system (e.g., search engines, external sensors, other electronic devices, etc.), to assign a priority to each potential interaction structure or representation that relates to current input being processed. The priority module comprises a component of application-specific information or processes that can be changed for each application. The priority calculation is done through rule-based, statistical, heuristic, or hybrid techniques used alone or in combination, including but not limited to decision trees, kernel methods, Bayesian methods, neural nets, and other types of machine learning or classification, heuristics, abductive reasoning, deductive reasoning, inductive reasoning, or voting schemes.

Information used in the priority calculation, or attribute scoring, can include, but is not limited to, the following types:
1. Urgency information. What constitutes an urgent message differs from modality-to-modality or from domain-to-domain. Modalities can also have an expected urgency relative to each other.
2. The subject area and content of the current active interaction structure. Interactions that continue the current interaction structure would have higher priority, other features being equal, than interactions that launch a new interaction subject area or relate to a prior interaction subject area.
3. Information specific to the domain. For example, process A must be completed before process B.
4. History of the current interaction.
5. Patterns in the history of prior interactions or deviations from a baseline of interaction showing a user's typical response or action or the user's preferences.
6. General user preferences. Note that preferences are contemplated including user-defined, system defined, group defined or inherited, learned preferences, or others.

One possible approach for determining execution order of the interaction guide queue based on priority can found in Appendix A titled “Assigning Execution Order”.

As mentioned previously the inventive subject matter is considered to extend beyond just priority-based queue management. One should further appreciate that interactions among entities can be mapped to multiple dimensions of relevance. An interaction can be considered a quantification of an interplay, possibly based on an interaction signature derived from sensor data or types of sensor data, where the interaction can be analyzed according to one or more dimensions. Example dimensions of relevance can include various factors possibly including the initiator of the interaction, actors/entities of the interaction, mode of analysis (e.g., embedded, multi-threaded, hybrid, etc.) goals, topics, agenda, functions, purpose, priority, or other factors that can affect which interaction guide should be processed before others. In some embodiments, the dimensions of relevance can overlap each other (e.g., importance and urgency). Further, dimensions can also be non-overlapping (i.e., orthogonal); location and time, for example.

With respect to initiators, a dimension on which interactions can vary includes which participant controls the conversation. In human-computer interactions three possible options include system-initiative, user-initiative and mixed-initiative. Call center applications are examples of system-initiative, where the system asks the caller questions (e.g., “What is your account number?”, “Checking or Savings?”, “Would you like to get the current balance, last transaction, pending payments or last transfer?”, etc.). A user simply responds to the system's agenda. The system is completely in control of the flow of conversation and the range of possible user responses. A spoken interface to a search engine is an example of a user-initiative system. A system of this type merely responds to a user's search query (e.g., “find me a restaurant near here”, etc.) and would have no ongoing agenda of its own. The user initiates all interaction. In a mixed-initiative system the user and the system can both have agendas and each has control in different parts of the interaction. An example of mixed-initiative can include a system in a car for controlling entertainment that also reports information related to the state of the car, such as needing gas or information about performance issues. The car system's agenda would be to report information that it had access to due to sensors, which would be independent of the user's agenda to play music. The car initiates conversations about needing gas and the user initiates conversations about playing music.

Each dimension of relevance can affect queue management of interaction guides according to their own attributes. For example, interactions that have urgency could affect queue priority processing, while other dimensions of relevance (e.g., location) might not affect queue processing.

One aspect of the inventive subject matter includes initiating one or more actions based on analysis of an interaction according to one or more dimensions of relevance. For example, an electronic device can acquire a digital representation of an interaction, possibly including local or remote sensor data. One should appreciate the sensor data comprise different or even multiple modalities of data including visual data, auditory data (e.g., human speech), text data, tactile data, taste data, ambient/background data, or other types of data. An interaction analysis engine obtains the digital representation and then can differentiate one or more conceptual threads associated with the interaction data, possibly based on one or more dimensions of relevance. One should appreciate that a conceptual thread can be broken apart into individual units possibly where the conceptual threads are analyzed in a serialized fashion or parallel fashion. For example, the conceptual threads can be mapped to one or more Meaning Invariant Units (MIUs) where the MIUs represent modality invariant and language invariant quantification of action-based meaning associated with the interaction.

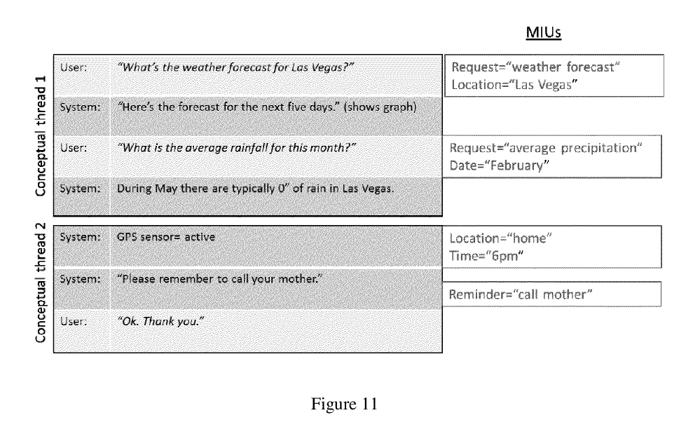

FIG. 11 depicts the mapping of conceptual threads to MIUs. Two example conceptual threads are illustrated. In the first conceptual thread example, the user asks the system about the weather in Las Vegas. The system resolves the request to the two elemental semantic entities or Meaning Invariant Units, “weather forecast” and the location, “Las Vegas”. Given these two Meaning Invariant Units, the system has enough information as to know how and what to respond. It returns a five day forecast depicted in a graph. The user continues asking about the average rainfall for “this month”. This request maps to the two MIUs “average precipitation” and the month “February”. The system factors the two new MIUs in relation to the previously mapped MIUs “weather forecast” and the location “Las Vegas”. This provides sufficient information to construct a system response addressing the average rainfall in Las Vegas for the month in question.

The second example in FIG. 11 depicts the influence of sensor data on a conversational initiative. A user has previously asked the system to remind him to make a telephone call at 6:00 pm when he returns to his home. The request would resolve to a reminder, location and time MIUs. Given that the GPS sensor is active, the system knows where the user is and when the user has returned home. At the appointed time, the system initiates a dialog with the reminder to “call mother”.

In some embodiments, interactions or the initiated actions, can be driven by observed changes with respect to a baseline behavior. Thus, the interaction analysis engine can monitor one or more interactions to establish a baseline behavior as a function of the observed sensor data. For example, as the interaction analysis engine acquires digital representations of interactions, the engine can determine a baseline description of each type of interaction as a function of sensor data or modalities of sensor data; a vector, N-tuple, or other type of descriptor. Further, the interaction analysis engine can establish a baseline of interactions representing one or more sets of behaviors that could be considered nominal behavior. When the interaction analysis engine detects a deviation from a baseline interaction, or the baseline of interactions, the interaction analysis engine can map the deviation to a conceptual tread, establish a breakpoint between conceptual threads, map the deviation to an MIU, or modify interaction guides in a queue of interaction guides. A practical example could include detecting that a user has failed to take a medication, which causes an interaction guide to rise in priority to the point where it generates a reminder on one or more of the user's electronic devices.

Based on information obtained from the conceptual threads, the interaction analysis engine can modify a queue of interaction guides. The interaction guides, as discussed previously, are frameworks that provide instructions to computing devices (e.g., cell phones, etc.) to continue in an interaction. The analysis engine can convert the conceptual threads information into domain-specific, or even device specific, instructions or interaction guides. Further, the analysis engine can derive one or more attributes from the properties of the conceptual threads as relating to a specific dimension of relevance for the current interaction. In some embodiments, the conceptual threads can comprise templates having “blank” properties that take on values based on the interaction data or conceptual threads. The derived attributes can then be used to modify the queue as appropriate. As discussed previously, one attribute could include priority.

Note that when conceptual threads are differentiated, they can be differentiated in different ways. They might concern different topics, they might have different participants (for example a person talking on the phone and with some other live person), they might have related topics, or they might have unrelated topics, etc. Thus, the way in which a conceptual thread is differentiated can give rise to different attributes which in turn can affect the queue of interaction guides.

FIGS. 6-10 depict the methods for modifying the queue can include creating a queue, deleting a queue, removing queue items, inserting into the queue, re-ordering the queue, adding to the queue, changing state of a queue item (e.g., active, sleep, dormant, etc.), merging queue items, prioritizing the queue, or other types of queue manipulations. In view that there can be multiple modalities or multiple dimensions of relevance, one should appreciate that there can also be multiple queues for an interaction. Consider an example of a computer rendering of an interactive assistant. There could be queues for handling voice, visual presentation, emotional state, or other aspects of the rendered assistant. Each queue can be processed independently of each other, or could depend on each other to ensure synchronization of multi-dimensional or multi-modal interactions.

An interesting aspect of processing conceptual threads includes identifying or establishing breakpoints between conceptual threads in an interaction, especially within a multi-modal interaction. One aspect of the inventive subject matter includes identifying breakpoints between two conceptual threads during an interaction. The breakpoints can be identified based on a number of factors including shifts in dimensions of relevance, a time, a location, an initiator, a speaker, a context change, a modality shift, a sensed urgency, a tone, a manually inserted instruction from a user or analysis engine, metadata, or other factors. For example, a person might be speaking into a cell phone via a wireless Bluetooth connection in a calm tone while gesticulating violently. The calm tone might denote continuation of a first conceptual thread while the onset of a violent motion detected via an accelerometer might indicate a breakpoint in the first conceptual thread or introduction of a second conceptual thread having a high priority or urgency.

Of particular note one should appreciate that queue processing of interaction guides can occur in real-time during an interaction, or can occur over extended periods of time. Thus interaction guides can be bound to historical conceptual threads spreading over minutes, hours, days, weeks, months, years, or even longer time frames.

Yet another aspect of the inventive subject matter includes recalling historical interactions or associated conceptual threads. As the contemplated analysis engine manages the various interactive guide queues, the engine can recall previous interactions or conceptual threads as a function of their corresponding dimensions of relevance, attributes, properties, or other triggering characteristics. The recalled interactions or corresponding interaction guides can then be folded into a current queue for processing. Thus, the interaction guides can be added or removed from a current processing queue as a function of time or age.

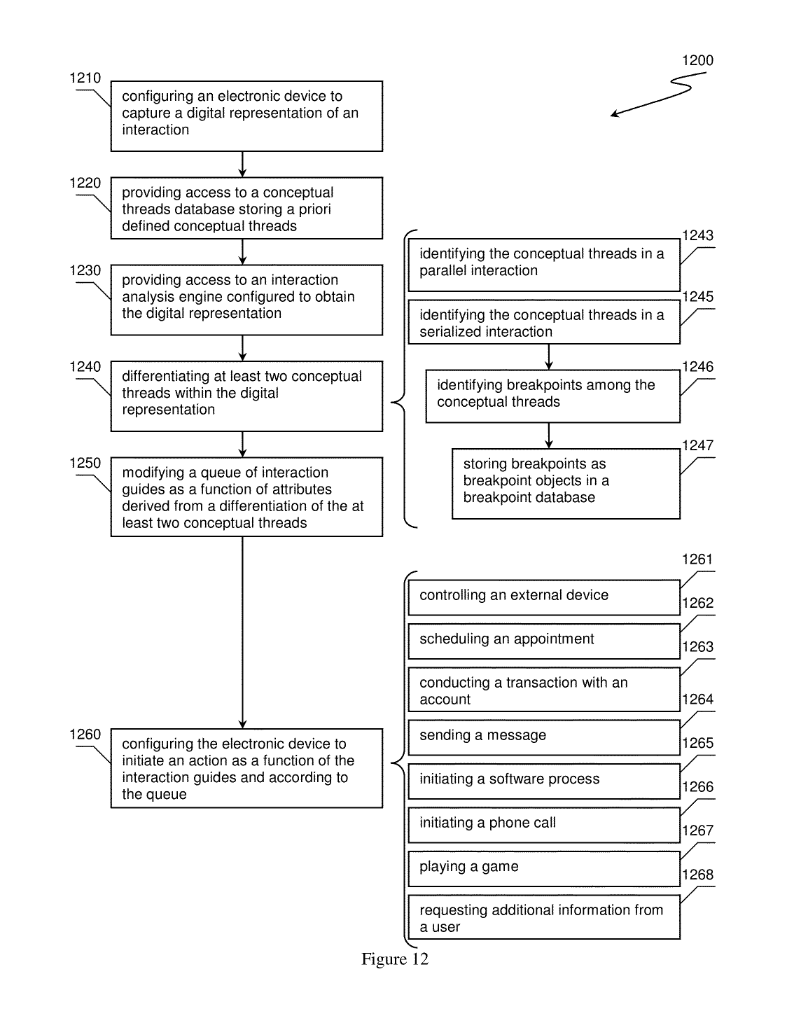

FIG. 12 illustrates a possible method 1200 of initiating actions based on multi-dimensional interactions. Step 1210 includes configuring an electronic device to capture a digital representation of an interaction. This could be using a microphone to capture a speech signal and streaming it to a speech recognition server, or a touch screen that picks up user's touch.

Step 1220 can include providing access to a conceptual threads database storing a priori defined conceptual threads. Conceptual thread objects can be viewed as dialog templates that contain a set of variables for concepts associated with this thread object as well as a set of possible actions that can be triggered by evaluating the set of concept variables. Each conceptual thread object is stored in one table in the conceptual thread database and is identified by a unique name. The NULL thread is a thread for the ‘empty’ or ‘blank slate’ situation. This NULL thread is active at the start of a system.

Step 1230 includes providing access to an interaction analysis engine coupled with the electronic device and possibly with the conceptual threads database. The electronic analysis engine can be configured to obtain the digital representation of the interaction.

Step 1240 includes differentiating a least two conceptual threads based on the digital representations of the interaction. Each time the system receives new digital representations, these representations are being mapped to at least two conceptual threads with the help of a statistical classifier such as for example a Support Vector Machine (SVM). For each set of digital representations there will be a ranked list of matching conceptual threads, where each matched conceptual thread is being assigned a matching score. This matching score is later on one component of the priority calculation (see step 1250).

One should appreciate that threads can be differentiated based on the nature of the interactions. For example, step 1243 can include identifying the conceptual threads within a parallel interaction. A parallel interaction is considered to include multiple observed actions taking place substantially at the same time, possible including speaking at the same time as gesturing. Additionally, step 1245 can include identifying the conceptual threads within a serialized interaction. A serialized interaction could simply include a spoken dialog where multiple people speak to each other in turns.

Interestingly, serialized interactions allow for detecting breaking points from one thread to another. In some embodiment, method 1200 can include identifying breakpoints among the conceptual threads as indicated by step 1246. Further, step 1247 can include storing breakpoints as breakpoint objects in the breakpoint database. Breakpoints are a combination of one or more digital representations of an interaction that indicate a switch. Examples of breakpoint specific digital representations are inputs from a different speaker or a system rule triggering a reminder. Breakpoints can be seen as a special set of digital representations of interactions that indicate a change of topic. For example, certain keywords such as ‘oh, by the way’, or ‘on a different note’ might indicate a change of topic and will be marked as a breakpoint. These breakpoints are used in combination with other digital representations of interactions to perform the priority function calculation.

Step 1250 includes modifying a queue of interaction guides as a function of the attributes derived from a differentiation of the conceptual threads. The first step consists of mapping the incoming digital representations to attributes such as location, time, topic marker, user name or other tags that represent meaning or data. During this step, breakpoints are also indentified. Yet other kinds of attributes are the priority that is assigned each interaction guide, the trigger of a system timer to start a different thread or an alert for low phone battery levels. The priority of each conceptual thread is being calculated as a function of the priority of a conceptual thread, the number of matching attributes, whether it is matching the currently LIVE conceptual thread and whether there are any breakpoints present. Once the priority for each currently active conceptual thread has been calculated, the interaction guide queue is updated as shown in FIGS. 6-10.

The differentiation between conceptual threads is given via four components. First, there is the fact if breakpoints are assigned to the current digital representation. Next, the overlap between the current attributes and the currently active interaction guide is calculated as a “matchedness” score. For example if there are three attributes and only one of them matches the current interaction guide but all three match a different interaction guide, then this is a strong indicator for a switch of the conceptual thread and to make the interaction guide where all three attributes match the new LIVE interaction guide. Thirdly, the priority function calculation provides an indicator as to the urgency of all active interaction guides and thus which interaction guide such be given the priority and be made the LIVE interaction guide. Fourthly, since it is human nature to assume that a conversational partner is continuing a current conceptual thread unless there is an indicator that this is not the case, the current LIVE interaction guide will always have a bias associated with it. It is the combination of all these factors that determines the currently LIVE conceptual thread.

Step 1260 includes configuring the electronic device to initiate an action as a function of the interaction guide and according to the modified interaction action. Such an electronic device could be a mobile phone, a computer, a home entertainment remote control, a home security system control unit. Each such device can be configured to access the interaction guides and the priority queue via an API, embedded into a virtual machine or a mobile application. Some components of the systems might be stored locally on the device while other components such as for example the priority function location or the conceptual thread database might be stored on a server in the cloud.

Steps 1261 to 1268 provide examples of actions the device can take. For example, a user might be conducting a transaction with a banking account 1263, when a timer triggers a previously schedule reminder to call his mother. The triggering of the timer represents a breakpoint and forces the system to update the queue of interaction guides by evaluating the new incoming interaction by the priority function as to whether a new conceptual thread should be started and whether this new thread.

Another example would be where the user is in the middle of configuring the heating schedule 1262 in his home when he remembers that he has to schedule an appointment 1263. In this case, he might say something like ‘oh, put that on hold. I need to schedule a repairman to come out.’ The words ‘oh, put that on hold’ represent a breakpoint and the system will determine that a new conceptual thread is being started and since the new thread has been explicitly requested from the use it is being assigned a high priority and will result in the new thread being put on top of the queue, i.e. becoming the LIVE conceptual thread.

### APPENDIX A

### Assigning Execution Order

The following describes a possible approach for prioritizing and executing interaction guides within an interaction guide queue.

An Interaction Manager can operate according to the principle of preemptive multitasking, which involves the use of an interrupt mechanism. The interrupt mechanism suspends the currently executing process and invokes a scheduler to determine which process, or interaction guide, should execute next in the case that a new interaction guide arrives at the Interaction Manager.

In order to determine the next interaction guide to execute, the Interaction Manager needs to decide whether the new incoming interaction guide is more important than the interaction guide that is currently active. Importance can be derived from one or more attributes. Priority is an example.

The priority of an interaction guide is a priority that can be defined by a subject matter expert during the interaction guide creation process. A set of priority values can include the set of [1, 3, 5, 7, 9], where 5 is a default, nominal value. This mechanism allows for individual priority assignments, or a hierarchy of priorities.

Additionally, a user can override the priority of an interaction guide during interactions with the system by one or more inputs possibly including answering a system question, such as “How important is this reminder to you? High, medium or low?”, when creating a reminder, or by saying things like “Don't disturb me for the next two hours”. If this happens, the interaction guide's priority gets increased or decreased by 1.

Now, when a new interaction guide arrives at the Interaction Manager, the following pseudo code represents possible rules that can be evaluated to determine execution order:
Case 1 (active interaction guide is very important and shouldn't be interrupted, i.e. priority is at least 2 points higher than new interaction guides priority):

If new interaction guide priority +2 < active interaction guide priority

Then ‘acknowledge that user wants to change but ignore the change
request’

Case 2 (new interaction guide is less important than active interaction guide):

Elsif new interaction guide priority < active interaction guide priority

If confidence of new interaction guide > Threshold A

Then new interaction guide becomes the active interaction guide

If new interaction guide confidence > Threshold B

Then confirm with user if he/she wants to switch

Else activate NoMatch ErrorTemplate

Case 3 (new interaction guide is more important than active interaction guide):

Elsif new interaction guide priority active interaction guide priority

If new interaction guide confidence > Threshold B

Then confirm interaction guide switch with user

Else active NoMatchErrorTemplate

A confidence can include the interaction guide's confidence as assigned by a Support Vector Machine (SVM). ‘Threshold A’ and ‘Threshold B’ are two different confidence threshold settings that basically indicate how certain the system is that it understood the user's query correctly. In other words, if the system recognized a topic switch with low confidence, it is very likely a system mistake and consequently should be ignored.

Implementing such an execution order assignment mechanism ensures that a topic switch only occurs if the new interaction guide is important and the system's confidence is high enough to warrant the switch.

If two interaction guides have the same priority, one of them can be randomly executed first, possibly according to one or more weighting factors. For example, two or more interaction guides having the same priority could be weighted according to domain-specific information, MIUs, conceptual threads, or other factors.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of initiating actions based on multi-dimensional interactions, the method comprising:
configuring an electronic device to capture a digital representation of a interaction;
providing access to an interaction analysis engine coupled with the electronic device and configured to obtain the digital representation of the interaction;
differentiating, by the interaction analysis engine, at least two conceptual threads within the digital representation of the interaction;
modifying, by the interaction analysis engine, a queue of interaction guides as a function of attributes derived from differentiation of the at least two conceptual threads; and
configuring the electronic device to initiate an action as a function of the interaction guides and according to the queue.

2. The method of claim 1, further comprising providing access to a conceptual threads database storing a priori defined conceptual threads.

3. The method of claim 1, wherein the step of differentiating comprises identifying the at least two conceptual threads in a serialized interaction.

4. The method of claim 3, further comprising identifying a breakpoint between the at least two conceptual threads.

5. The method of claim 4, further comprising storing the breakpoint as a breakpoint object in a breakpoint database.

6. The method of claim 5, wherein the breakpoint object comprises attributes including at least one of the following: a time, a location, a speaker, a context change, a modality shift, a sensed urgency, a tone, an manually inserted instruction, and metadata.

7. The method of claim 1, wherein the step of differentiating comprises identifying the at least two conceptual threads in a parallel interaction.

8. The method of claim 1, wherein the at least one conceptual thread comprises a NULL conceptual thread.

9. The method of claim 1, wherein the interaction comprises human speech.

10. The method of claim 1, wherein the interaction comprises multiple modalities.

11. The method of claim 10, wherein the interaction comprises human speech and at least one of the following modalities: text data, visual data, kinesthetic data, auditory data, taste data, and ambient data.

12. The method of claim 1, wherein the step of modifying the queue includes at least one of the following queue actions: queue creation, queue deletion, add an interaction guide, remove an interaction guide, prioritize an interaction guide, modify an interaction guide, insert an interaction guide, merge an interaction guide, change a state of an interaction guide, and re-order an interaction guide.

13. The method of claim 1, further comprising the electronic device initiating the action of controlling an external device.

14. The method of claim 1, further comprising the electronic device initiating the action of scheduling an appointment.

15. The method of claim 1, further comprising the electronic device initiating the action of conducting a transaction with an account.

16. The method of claim 1, further comprising the electronic device initiating the action of sending a message.

17. The method of claim 1, further comprising the electronic device initiating the action of initiating a software process.

18. The method of claim 1, further comprising the electronic device initiating the action of initiating a phone call.

19. The method of claim 1, further comprising the electronic device initiating the action of playing a game.

20. The method of claim 1, further comprising the electronic device initiating the action of requesting additional information from a user.

21. The method of claim 1, wherein the queue comprises a priority-based queue.

22. The method of claim 1, wherein the derived attributes include at least one of the following: a priority, an urgency, an importance, and an initiator.

23. The method of claim 1, wherein the interaction guide comprises a domain-specific interaction guide.
